(19) United States
(12) Patent Application Publication
(10) Pub. No.: US 2014/0189600 A1
(43) Pub. Date: Jul. 3, 2014

(54) DISPLAY APPARATUS AND METHOD FOR CONTROLLING DISPLAY APPARATUS THEREOF

(71) Applicant: SAMSUNG ELECTRONICS CO., LTD., Suwon-si (KR)

(72) Inventors: Dong-heon LEE, Seoul (KR); Jung-geun KIM, Suwon-si (KR); Sung-hyun JANG, Seoul (KR); Jae-kwon KIM, Suwon-si (KR)

(73) Assignee: SAMSUNG ELECTRONICS CO., LTD., Suwon-si (KR)

(21) Appl. No.: 14/107,506

(22) Filed: Dec. 16, 2013

(30) Foreign Application Priority Data
Dec. 31, 2012 (KR) 10-2012-0158441

(51) Int. Cl. G06F 3/0481

(52) U.S. Cl. CPC G06F 3/04812
USPC 715/856

(57) ABSTRACT

A display apparatus and a method for controlling a display apparatus thereof are provided. The method for controlling a display apparatus includes displaying a pointer to perform a motion task mode according to a predetermined event, displaying a Graphical User Interface (GUI) to provide a motion guide in an area close to the pointer, and when the pointer is moved according to a user motion, changing and displaying a display state of the GUI.

### CROSS-REFERENCE TO RELATED APPLICATIONS

This application claims priority from Korean Patent Application No. 10-2012-0158441, filed in the Korean Intellectual Property Office on Dec. 31, 2012, the disclosure of which is incorporated herein by reference.

### BACKGROUND

1. Field

Methods and apparatuses consistent with the exemplary embodiments relate to a display apparatus and a method for controlling a display apparatus thereof, and more particularly, to a display apparatus which is controlled by a user motion and a method for controlling a display apparatus thereof.

2. Description of the Related Art

Recently, with the development of electronic technology, various types of display apparatuses have been developed. In particular, various types of display apparatuses including a television have been used in general households. Such display apparatuses are providing more and more functions in accordance with users' increasing needs. In particular, televisions may be connected to the Internet, and may even provide Internet services. In addition, a user may watch a plurality of digital broadcasting channels through a television.

Accordingly, various input methods are required to use various functions of a display apparatus effectively. For example, various input methods such as an input method using a remote controller, a mouse, and a touch pad are applied to an electronic apparatus.

However, there are difficulties in utilizing various functions of a display apparatus with such a simple input method.

For example, when all of the functions of a display apparatus are controlled by a remote controller, it is inevitable that the number of buttons of the remote controller have to be increased. In this case, it is not easy for a general user to become familiar with the method for using such a remote controller.

Alternatively, when various menus are displayed on the screen, in order for a user to search and select each and every menu, the user has to check all of the complicated menu trees in order to find a desired menu, thus causing inconvenience to the user. To resolve this inconvenience, a guide to explain the functions of each specific menu are displayed for the user. However, a menu for such a guide is usually displayed on the bottom of the screen, making it difficult for the user to recognize the menu.

Accordingly, a technology to enable a user to control a display apparatus in a more convenient and intuitive manner is required.

### SUMMARY

An aspect of the exemplary embodiments relates to a display apparatus which is controlled by a user's motion, and draws the attention of a user to a motion guide when the guide regarding available motions is provided, while minimizing interference with the display apparatus, and a method for controlling a display apparatus thereof.

A method for controlling a display apparatus according to an exemplary embodiment includes displaying a pointer to perform a motion task mode according to a predetermined event, displaying a Graphical User Interface (GUI) to provide a motion guide in an area close to the pointer, and when the pointer is moved according to a user's motion, changing and displaying a display state of the GUI.

The method may further include, when the GUI is selected by the pointer according to the user's motion, displaying a guide regarding available motions in a motion task mode.

The changing and displaying a display state of the GUI may include, when the pointer is moved within a predetermined area with reference to a location where the pointer is displayed initially, adjusting and displaying a transparency of the GUI according to a location where the pointer is moved.

The changing and displaying a display state of the GUI may include increasing and displaying a transparency of the GUI gradually as the pointer moves away from the location where the pointer is displayed initially, and decreasing and displaying a transparency of the GUI gradually as the pointer moves closer to the location where the pointer is displayed initially, within the predetermined area.

The changing and displaying a display state of the GUI may include removing the GUI when the pointer goes beyond the predetermined area and maintaining the display state of the GUI in the removed state even when the pointer moves back to the predetermined area, that is, maintaining the display state where the GUI is removed.

The changing and displaying a display state of the GUI may include removing the GUI when a predetermined time is elapsed since the pointer is displayed initially.

A display apparatus according to an exemplary embodiment includes a display, a motion input device configured to receive a user's motion, and a controller configured to display a pointer to perform a motion task mode according to a predetermined event, control the display to display a GUI to provide a motion guide in an area close to the pointer, move the pointer according to a user motion, and change and display a display state of the GUI according to a motion of the pointer.

The controller, when the GUI is selected by the pointer according to the user's motion, may display a guide regarding available motions in a motion task mode.

The controller, when the pointer is moved within a predetermined area with reference to a location where the pointer is displayed initially, may adjust and display a transparency of the GUI according to a location where the pointer is moved.

The controller may increase and display a transparency of the GUI gradually as the pointer moves away from the location where the pointer is displayed initially, and decrease and display a transparency of the GUI gradually as the pointer moves closer to the location where the pointer is displayed initially, within the predetermined area.

The controller may remove the GUI when the pointer goes beyond the predetermined area and maintain the display state of the GUI in a removed state even when the pointer moves back to the predetermined area, that is, maintain the display state where the GUI is removed.

The controller may remove the GUI when a predetermined time is elapsed since the pointer is displayed initially.

According to various exemplary embodiments, it is possible to control a display apparatus by a user's motion and thus, user convenience can be improved.

In addition, as a menu to provide a motion guide is displayed in an area close to a pointer, and the display state of the corresponding menu can be changed according to the motion of the pointer, it is possible to draw a user's attention to the motion guide while minimizing interference with the user's viewing of the screen.

### BRIEF DESCRIPTION OF THE DRAWINGS

The above and/or other aspects will be more apparent by describing certain exemplary embodiments with reference to the accompanying drawings, in which:

FIG. 1 is a view which illustrates a display apparatus which is controlled by a motion task mode according to an exemplary embodiment;

FIG. 2 is a schematic block diagram illustrating a display apparatus according to an exemplary embodiment;

FIG. 3 is a block diagram illustrating the configuration of the display apparatus in FIG. 2 in detail;

FIGS. 4 to 10 are views illustrating operations of a display apparatus according to exemplary embodiments; and

FIG. 11 is a flowchart which illustrates a method for controlling a display apparatus according to an exemplary embodiment.

### DETAILED DESCRIPTION OF EXEMPLARY EMBODIMENTS

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the application with unnecessary detail.

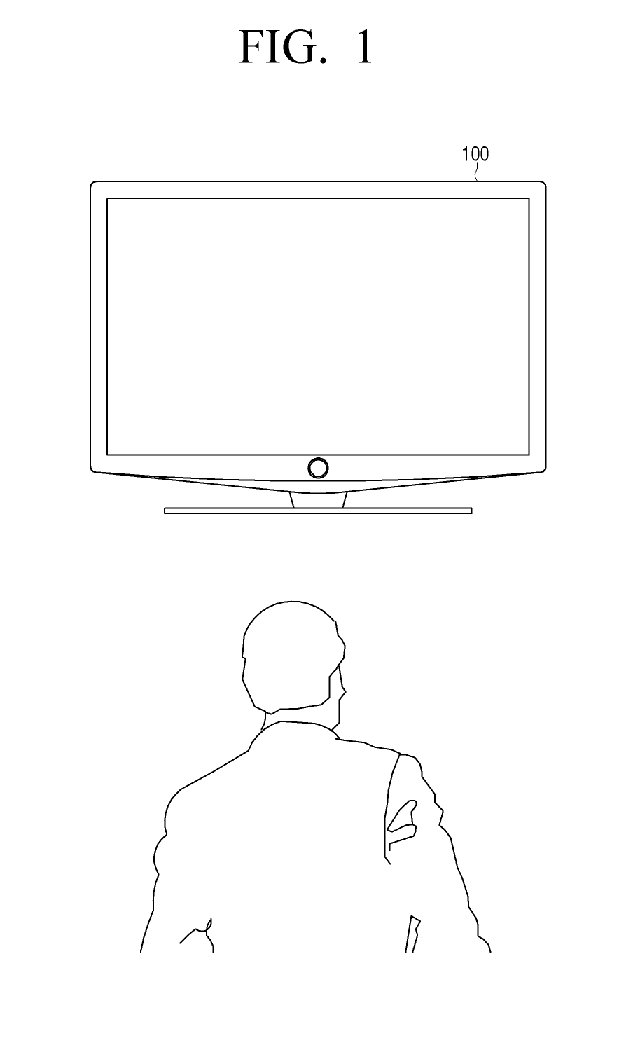

FIG. 1 is a view which illustrates a display apparatus which is controlled by a motion task mode according to an exemplary embodiment. Herein, the motion task mode refers to a mode where the display apparatus 100 is controlled by a user's motion.

Once the motion task mode is started, the display apparatus 100 may recognize a user's motion and execute a task corresponding to the recognized user motion. For example, when a user's motion to move a pointer on a screen is recognized, the display apparatus 100 may move the pointer displayed on the screen. Alternatively, when a user's motion to select a GUI displayed on the screen is recognized, the display apparatus 100 may execute a task corresponding to the GUI (for example, turn power on/off, change channel, control volume, reproduce contents (such as video, music, photo, etc.), perform web browsing, etc.).

In addition, the display apparatus 100 may display a Graphic User Interface (GUI) to provide a motion guide in an area near the pointer, and when the corresponding GUI is selected, may display a guide regarding available motions in the motion task mode. For example, when a GUI to provide a motion guide is selected, the display apparatus 100 may move the pointer through the motion of moving a hand left/right or up/down and display a guide including information that a menu where the pointer is located can be selected through the motion of clenching a hand, and so on.

In this case, when the pointer is moved according to a user's motion, the display apparatus 100 may change the display state of the GUI to provide a motion guide. Specifically, the display apparatus 100 may adjust the transparency of the GUI or remove the GUI according to the location of the pointer which is moved by the user motion.

In addition, the display apparatus 100 may change the display state of the GUI to provide a motion guide depending on how much time has elapsed after the pointer is initially displayed. Specifically, the display apparatus 100 may remove the GUI when a predetermined time has elapsed after the pointer is displayed for the first time.

As such, the display apparatus 100 displays a GUI to provide a motion guide in an area close to the pointer, and thus may draw the attention of a user who is viewing the pointer. Further, display apparatus 100 changes the display state of the GUI depending on the location where the pointer is moved or the time which has been elapsed since the pointer is displayed for the first time and thus, may minimize user inconvenience caused by the GUI blocking the screen.

The display apparatus 100 may be realized as a television as illustrated in FIG. 1, but this is only exemplary. The display apparatus 100 may be realized as various types of electronic apparatuses such as a mobile phone, a desktop PC, a notebook PC, a tablet PC, and so on.

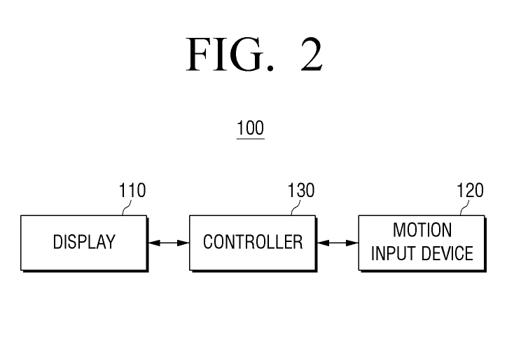

FIG. 2 is a schematic block diagram illustrating a display apparatus according to an exemplary embodiment. As illustrated in FIG. 2, the display apparatus 100 comprises a display 110, a motion input device 120, and a controller 130.

The display 110 displays various screens. Specifically, the display 110 may display an image corresponding to a broadcast signal and an image constituting various contents.

In addition, the display 110 displays various GUIs. Specifically, the display 110 may display a GUI to receive a user command to perform various tasks. For example, the display 110 may display GUIs to receive a user command to display a motion guide, turn power on/off, change channels, control volume, reproduce contents, perform web browsing, and so on. In particular, when a user command to display a motion guide is input, the display 110 may display a guide regarding available motions in the motion task mode.

To do so, the display 110 may be realized as a Liquid Crystal Display (LCD), an Organic Light Emitting Display (OLED), a Plasma Display Panel (PDP), or the like.

The motion input device 120 receives a user's motion. Specifically, the motion input device 120 may photograph a user's motion and provide the photographed image signal (for example, successive frames) to the controller 130. For example, the motion input device 120 may be realized as a camera unit consisting of a lens and an image sensor. In addition, the motion input device 120 may be formed integrally with the display apparatus 100 or separately from the display 100. When the motion input device 120 is provided separately from the display 100, the motion input device 120 may be connected to the display apparatus 100 via cable or wirelessly.

The controller 130 controls overall operations of the display apparatus 100. That is, the controller 130 may control the display 110 and the motion input device 120. The controller 130 may include Read Only Memory (ROM) and Random Access Memory (RAM) which store modules and data to control the display apparatus 100.

The controller 130 may control to recognize a motion input through the motion input device 120 and perform a task corresponding to the recognized motion (such as, the motion of moving a pointer, selecting a GUI using the pointer, turning power on/off, changing channels, controlling volume, reproducing contents, performing web browsing, and so on).

For example, the controller 130 detects the location and the shape of an object from an image signal transmitted from the motion input device 120 using at least one of the shape, color, and motion of the object. Herein, the object may be a user's hand. In addition, the controller 130 may detect the motion of the detected object (that is, motion direction, motion speed) using the location of the object included in each of a plurality of frames.

In addition, the controller 130 may recognize a user's motion based on the shape and motion of the recognized object, and perform a task corresponding to the recognized motion. In this case, the controller 130 may refer to a motion database where a predetermined motion and a motion task matching a predetermined motion are recorded.

For example, the motion database may store information where the grabbing motion of grabbing a hand is matched with a motion task to select a GUI on which a pointer is located, and the pointing move motion of moving a spread hand in one direction at less than a predetermined speed is matched with a motion task to move the pointer.

Accordingly, when the motion of grabbing a hand is recognized, the controller 130 may determine that it is a grab motion and perform a task corresponding to the GUI where the pointer is located. For example, when the pointer is located on the GUI to provide a motion guide, the controller 130 may display a guide regarding available motions in the motion task mode.

In addition, when the motion of moving a spread hand in one direction at less than a predetermined speed (for example, 30 cm/s) is recognized, the controller 130 may determine that the motion is the pointing move motion and perform the task of moving the pointer in the direction where the hand is moved.

However, this is only exemplary, and the controller 130 may recognize various motions other than the grab motion and the pointing move motion and perform the corresponding tasks.

For example, the motion database may store motion tasks corresponding to each of the slap motion of moving a spread hand in one direction at higher than a predetermined speed, the shake motion of shaking a hand left/right or up/down, the rotating motion of rotating a hand, the spread motion of spreading a clenched hand, and so on.

In this case, the controller 130 may control to determine a user's motion input from the motion input device 120 and perform a task matching each motion.

For example, when the motion of moving a spread hand in the left/right direction at higher than a predetermined speed is recognized, the controller 130 may determine the motion is the left/right slap motion and perform the task of turning channels up/down in the direction where the hand is moved. In another example, when the motion of moving a spread hand in up/down direction at higher than a predetermined speed, the controller 130 may determine that the motion is the up/down slap motion and perform the task of turning the volume up/down in the direction where the hand is moved.

The controller 130 may identify at least one of change in shape, speed, location, and direction of an object in order to determine or interpret a user's motion. For example, in order to determine whether a user's motion is a pointing move motion or a slap motion, the controller 130 determines whether an object moves beyond a predetermined area (for example, a square of 40 cm×40 cm) within a predetermined time (for example, 800 ms). When the object does not go beyond the predetermined area within the predetermined time, the controller 130 may determine that the user motion is a ‘pointing move’. However, when the object goes beyond the predetermined area within the predetermined time, the controller 130 may determine that the user's motion is a ‘slap’.

The controller 130 may control the display 110 to display a pointer to perform the motion task mode according to a predetermined event and display a GUI to provide a motion guide in an area close to the pointer. Herein, the area close to the pointer refers to an area within a predetermined distance from the pointer, but the controller 130 may display the GUI to provide a motion to be overlapped with the pointer.

In this case, the controller 130 may display the pointer and the GUI to provide a motion guide at the center of the screen simultaneously. However, this is only exemplary, and the controller 130 may display the pointer and the GUI to provide a motion guide on the upper, lower, left, or right side of the screen.

Herein, the predetermined event includes a motion start command to convert the mode of the display apparatus 100 to a motion task mode. The motion task mode refers to a mode where the display apparatus 100 is controlled by a user's motion input through the motion input device 120.

In this case, the motion start command may be input in various ways. For example, when the motion of a user's waving one hand left to right a plurality of times is input through the motion input device 120, the controller 130 may determine that a motion start command is input. In another exemplary embodiment, when a specific key on the manipulation panel of the display apparatus 100 is selected, or a specific control signal is received from a remote controller (not shown), the controller 130 may determine that a motion start command is input.

The controller 130 may move a pointer according to a user motion input through the motion input device 120. That is, when the pointing move motion of moving a spread hand at less than a predetermined speed is input through the motion input device 120, the controller 130 may move and display the pointer in the direction where the user's hand is moved.

In addition, when the GUI is selected by the pointer according to a user's motion, the controller 130 may display a guide regarding available motions in the motion task mode. That is, when the grab motion where a user clenches a hand is input through the motion input device 120 while the pointer which is moved according to the pointing move motion is located on the GUI to provide a motion guide, the controller 130 may display a guide regarding available motions in the motion task mode by performing a task corresponding to the GUI to provide a motion guide.

In this case, the guide may include information regarding tasks which can be performed by a user motion. For example, a guide may include information that a GUI where a pointer is located can be selected by a grab motion, a pointer can be moved by a pointing move motion, channels can be changed by a left/right slap motion, volume can be controlled by a up/down slap motion, and so on.

The controller 130 may provide different guides depending on applications which are currently being reproduced in the display apparatus 100. That is, a different task may be performed by the same motion depending on the application that is being used. Accordingly, a guide regarding available motions on the currently-reproduced application can be displayed.

For example, suppose that an application for web browsing is being executed. In this case, when a GUI to provide a motion guide is selected, the controller 130 may display a guide regarding available motions in the application for web browsing. That is, the controller 130 may display information that a GUI where a pointer is located can be selected by a grab motion, the pointer can be moved by a pointing move motion, a currently-displayed web page can be converted to another page by a left/right slap motion, a currently-displayed web page can be scrolled by an up/down slap motion, etc. as a guide.

The controller may control to change the display state of a GUI according to the motion of a pointer. That is, the controller 130 may change the display state of the GUI to provide a motion guide according to the motion of the pointer.

Specifically, when the pointer is moved within a predetermined area with respect to the location where the pointer is displayed for the first time, the controller 130 may adjust and display the transparency of the GUI according to the location where the pointer is moved. Herein the predetermined area refers to an area which includes the location where the pointer is displayed initially and has predetermined dimensions, and may be set and changed by a user.

More specifically, the controller 130 may increase and display the transparency of the GUI gradually as the pointer moves further away from the area where the pointer is displayed for the first time, and may decrease and display the transparency of the GUI gradually as the pointer moves closer to the area where the pointer is displayed for the first time, within a predetermined area. In this case, the controller 130 may increase the transparency of the GUI in proportion to the degree of how far the location of the pointer is away from the location where the pointer is displayed for the first time, and may decrease the transparency of the GUI in proportion to the degree of how close the location of the pointer is to the location where the pointer is displayed for the first time, within a predetermined area. In addition, when the pointer which has been moved within a predetermined area is returned to the location where the pointer is displayed for the first time, the controller 130 may display the GUI in its original state where the transparency is not controlled.

Further, when the pointer goes beyond a predetermined area, the controller 130 may remove the GUI, and even when the pointer which has been gone beyond the predetermined area reenters into the predetermined area, the controller 130 may maintain the display state of the GUI in the removed state, which means the controller 130 may not display the GUI.

In other words, when the pointer is moved within a predetermined area, the controller 130 may adjust and display the transparency of the GUI according to the distance between the location of the pointer and the location where the pointer is displayed for the first time, and when the pointer is returned to the location where it is displayed for the first time, may display the GUI in its original state where the transparency of the GUI is not controlled. However, when the pointer goes beyond the predetermined area, the controller 130 may remove the GUI from the screen and control not to display the GUI again even if the pointer moves back to the predetermined area.

Further, when a predetermined time has elapsed since the pointer is displayed for the first time, the controller 130 may change the display state of the GUI. Herein, the predetermined time may be set and changed by a user.

Specifically, when a predetermined time has elapsed since the pointer is displayed for the first time, the controller 130 may remove the GUI. That is, when a predetermined time has elapsed since the pointer is displayed for the first time, the controller 130 may remove the GUI from the screen even when the pointer moves within the predetermined area.

In the above exemplary embodiment, the controller 130 displays the pointer and the GUI to provide a motion guide at the same time when a predetermined event occurs, but this is only exemplary. That is, when various user commands are input while the pointer is displayed on the screen, the controller 130 may display the GUI to provide a motion guide in an area close to the pointer. For example, when the motion of a user's waving one hand left to right a plurality of times is input through the motion input device 120, a specific key on a manipulation panel of the display apparatus 100 is selected, or a specific control signal is received from a remote controller (not shown) while the pointer is displayed on the screen, the controller 130 may display the GUI to provide a motion guide in an area close to the pointer.

In this case, the controller 130 may adjust the transparency of the GUI according to the motion of the pointer with reference to the location where the pointer is displayed at a time when the motion guide is displayed. In this case, the predetermined area includes the location where the pointer is displayed at a time when the GUI to provide a motion guide is displayed. The predetermined area has predetermined dimensions, and may be set and changed by a user.

That is, the controller 130 may increase and display the transparency of the GUI as the pointer is moved away from the location where the pointer is displayed at a time when the GUI to provide a motion guide is displayed according to a user's motion, and may decrease and display the transparency of the GUI gradually as the pointer moves closer to the area where the pointer is displayed at a time when the GUI to provide a motion guide is displayed according to a user motion.

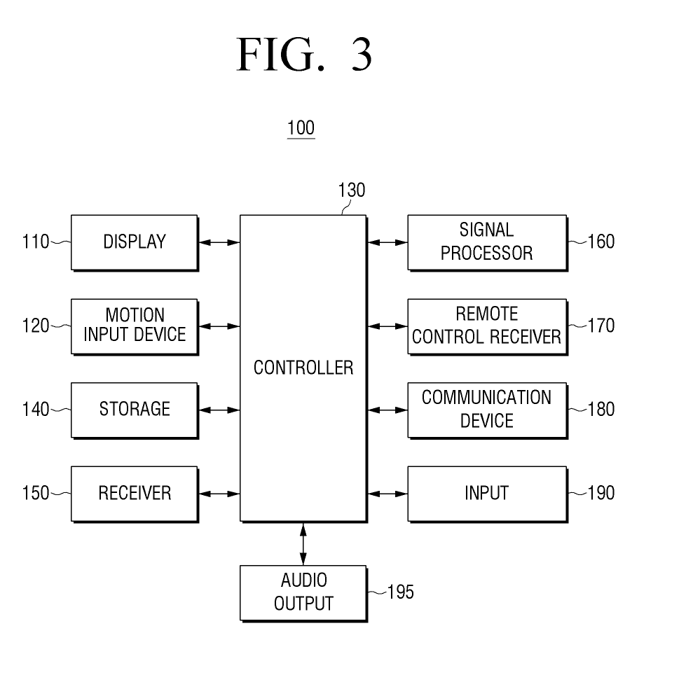

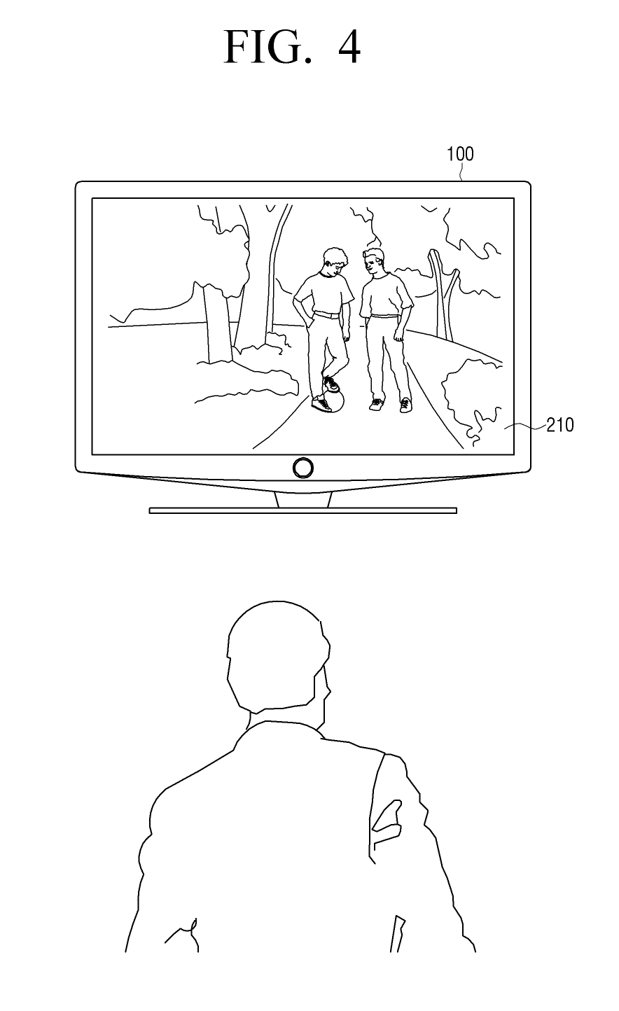

FIG. 3 is a block diagram illustrating the configuration of the display apparatus in FIG. 2 in detail. According to FIG. 3, the display apparatus 100 may further comprise a storage 140, a receiver 150, a signal processor 160, a remote control signal receiver 170, a communication device 180, an input 190, and an audio output 190 in addition to the components illustrated in FIG. 2, and the operations of the above components may be controlled by the controller 130.

The descriptions regarding the display 110, the motion input device 120 and the controller 130 illustrated in FIG. 3 are the same as those of the display 110, the motion input device 120 and the controller 130 in FIG. 2, further explanation will not be provided.

The storage 140 stores various data, application programs and execution programs which are required to drive and control the display apparatus 100. Specifically, the storage 140 may comprise a motion database where predetermined motions and motion tasks matching predetermined motions are recorded. The motion database has already been described above with reference to FIG. 2.

The receiver 150 may receive a broadcast signal. The broadcast signal may include an image, audio and additional data (for example, an Electronic Program Guide (EPG)), and the receiver 150 may receive a broadcast signal from various sources such as terrestrial broadcast, cable broadcast, satellite broadcast, Internet broadcast, and so on.

For example, the receiver 150 may be configured to include components such as a tuner (not shown), a modulator (not shown), an equalizer (not shown), etc. to receive a broadcast signal transmitted from a broadcasting station.

In addition, the receiver 150 may receive various contents from an external apparatus (not shown). To do so, the receiver 150 may include at least one of a High-Definition Multimedia Interface (HDMI) input terminal, a component input terminal, a PC input terminal, and a USB input terminal, but is not limited thereto.

The signal processor 160 performs signal processing with respect to a broadcast signal and contents received through the receiver 150. Specifically, the signal processor 160 performs operations such as decoding, scaling, and frame rate conversion with respect to an image constituting a broadcast signal or contents so that the image can be output in a display 110. In addition, the signal processor 160 may perform signal-processing such as decoding with respect to audio constituting a broadcast signal or contents so that the audio can be output in the audio output 195.

The remote control signal receiver 170 receives a control signal input from an external remote controller. The remote control signal receiver 170 may receive a remote control signal even when the mode of the display apparatus 100 is a motion task mode. The controller 130 may execute various tasks based on a control signal input to the remote control signal receiver 170. For example, the controller 130 may perform tasks such as turning power on/off, changing channels, controlling volume, etc. according to a control signal input from the remote control signal receiver 170.

The communication device 180 may connect the display apparatus 100 to an external apparatus (for example, a server). For example, the communication device 180 may connect the display apparatus 100 to an external apparatus using various communication methods such as wired/wireless Local Area Network (LAN), Wide Area Network (WAN), Ethernet, Bluetooth, Zigbee, Universal Serial Bus (USB), IEEE 1394, WiFi, and so on. To do so, the communication device 180 may comprise a chip, an input port, etc. corresponding to each communication method. For example, if the communication is performed using a wired LAN method, the communication device 180 may comprise a wired LAN card (not shown) and an input port (not shown).

In this case, the controller 130 may download an application from an external apparatus which is connected through the communication device 180 or perform web browsing. For example, the controller 130 may display a web page screen received from the external apparatus by executing an application for web browsing and transmit a user command input on the web page screen to the external apparatus in order to provide a user with web browsing.

The input 190 receives various user commands. The controller 130 may perform a task corresponding to a user command input from the input 190. For example, the controller 130 may turn power on/off, change channels, control volume, etc. according to a user command input from the input 190.

To do so, the input 190 may be realized as an input panel. The input panel may be realized as a touch pad, a key pad including various function keys, number keys, special keys, text keys, etc., or a touch screen.

The audio output 195 may be realized as an output port such as a jack or a speaker, and may output audio constituting a broadcast signal or contents.

Hereinafter, various exemplary embodiments will be explained with reference to FIGS. 4 to 10.

The controller 130 processes a broadcast signal received through the receiver 150 and displays a broadcast image on the screen as illustrated in FIG. 4.

In this case, if a motion start command is input, the controller 130 converts the mode of the display apparatus 100 to a motion task mode. In this case, the motion task mode refers to a mode where the display apparatus 100 is controlled by a motion input through the motion input device 120.

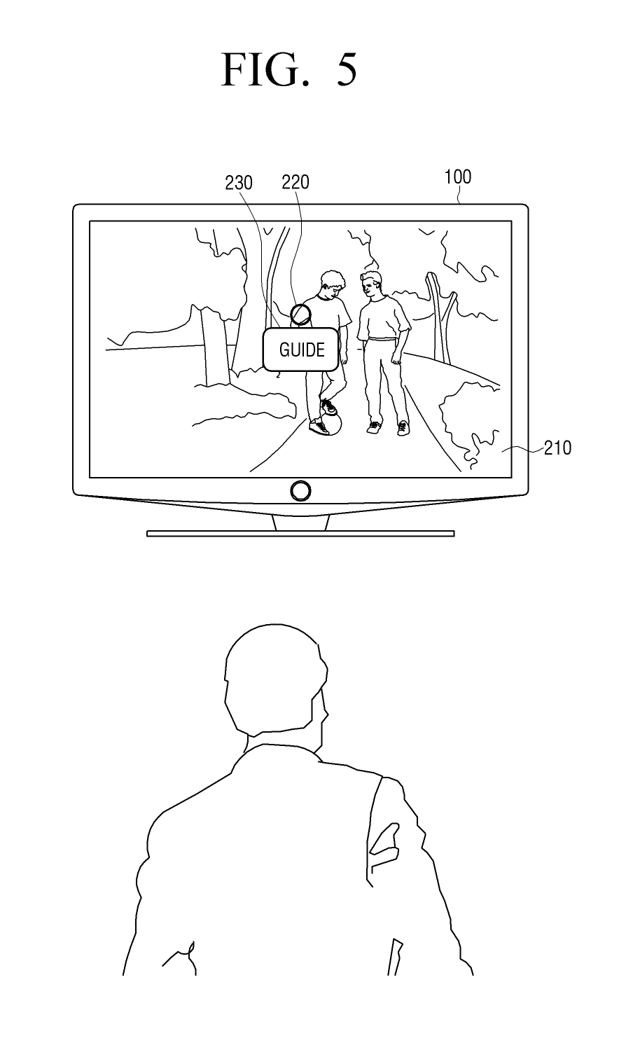

Once the mode is converted to the motion task mode, the controller 130 may display a pointer 220 and a GUI 230 to provide a motion guide at the center of the screen as illustrated in FIG. 5. In this case, the GUI 230 to provide a motion guide may be displayed in an area close to the pointer 220.

However, this is only exemplary, and the controller 130 may display the pointer 220 and the GUI 230 to provide a motion guide on an upper, lower, left or right side of the screen.

When the motion of moving a spread hand at less than a predetermined speed is input through the motion input device 120 while the pointer 220 and the GUI 230 to provide a motion guide are displayed, the controller 130 moves the pointer 220 in the direction where the hand is moved.

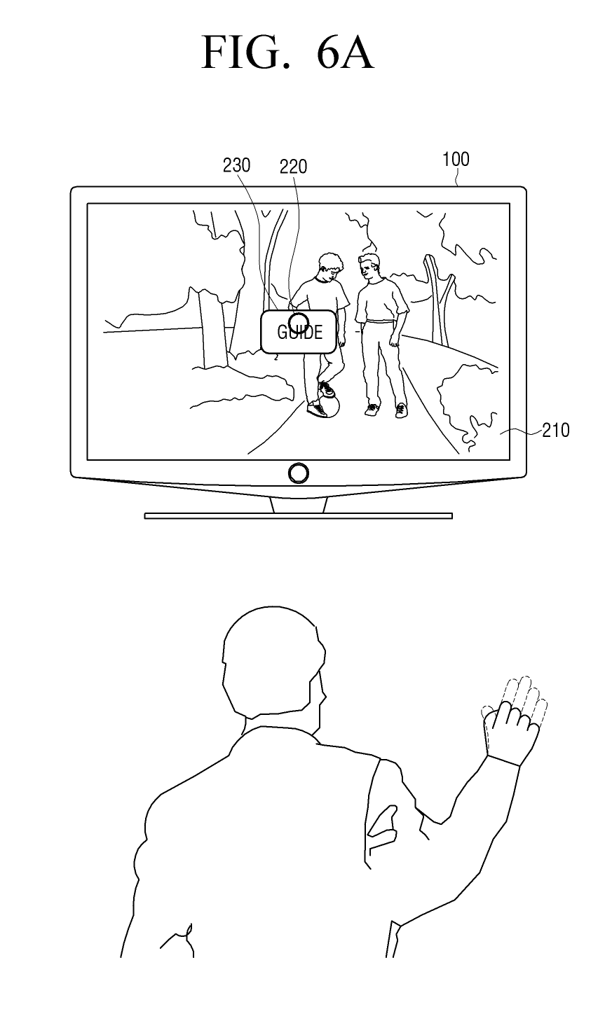

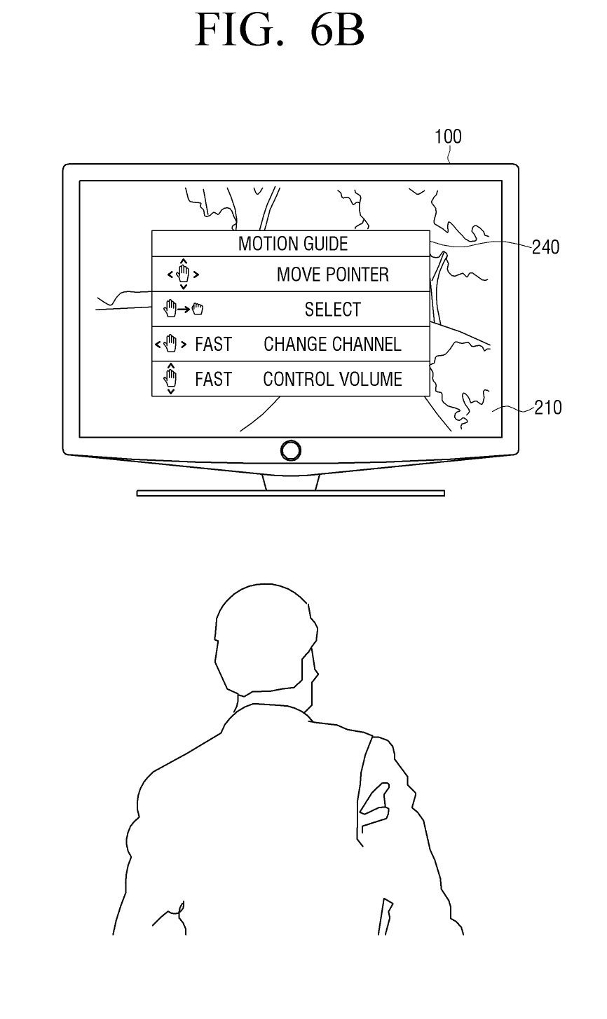

As illustrated in FIG. 6A, when the motion by a user of clenching a hand is input through the motion input device 120 while the pointer 220 is located on the GUI 230 to provide a motion guide, the controller 130 performs a function corresponding to the GUI 230. That is, the controller 130 may display a guide 240 (FIG. 6B) including information regarding available motions on the screen as illustrated in FIG. 6B.

In addition, the controller 130 may change the display state of the GUI 230 to provide a motion guide according to the motion of the pointer 220 when the pointer 220 is moved by a user motion.

Specifically, when the pointer 220 is moved within a predetermined area, the controller 130 may adjust the transparency of the GUI 230 to provide a motion guide according to the location of the moved pointer 220.

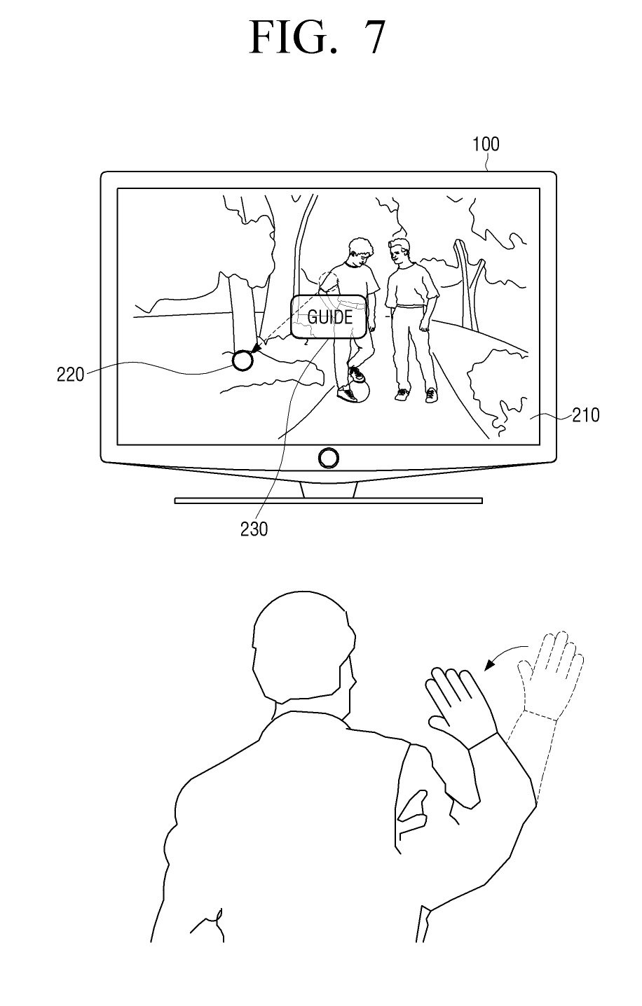

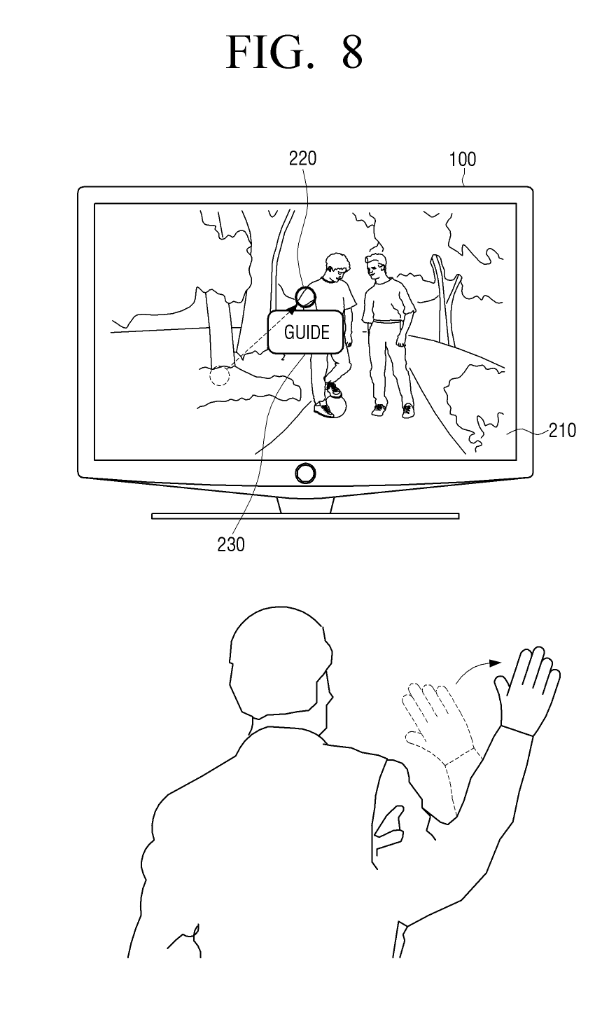

For example, as illustrated in FIG. 7, when the pointer 220 is moved by a user motion within a predetermined area, the controller 130 may increase and display the transparency of the GUI 230 to provide a motion guide gradually as the pointer 220 is moved further away from the location where the pointer 220 is displayed for the first time. In addition, as illustrated in FIG. 8, the controller may decrease and display the transparency of the GUI 230 to provide a motion guide gradually as the pointer 220 moves closer to the location where the pointer 220 is displayed for the first time. Further, when the pointer 220 is returned to its original location, the controller 130 may display the GUI 230 to provide a motion guide in its original state.

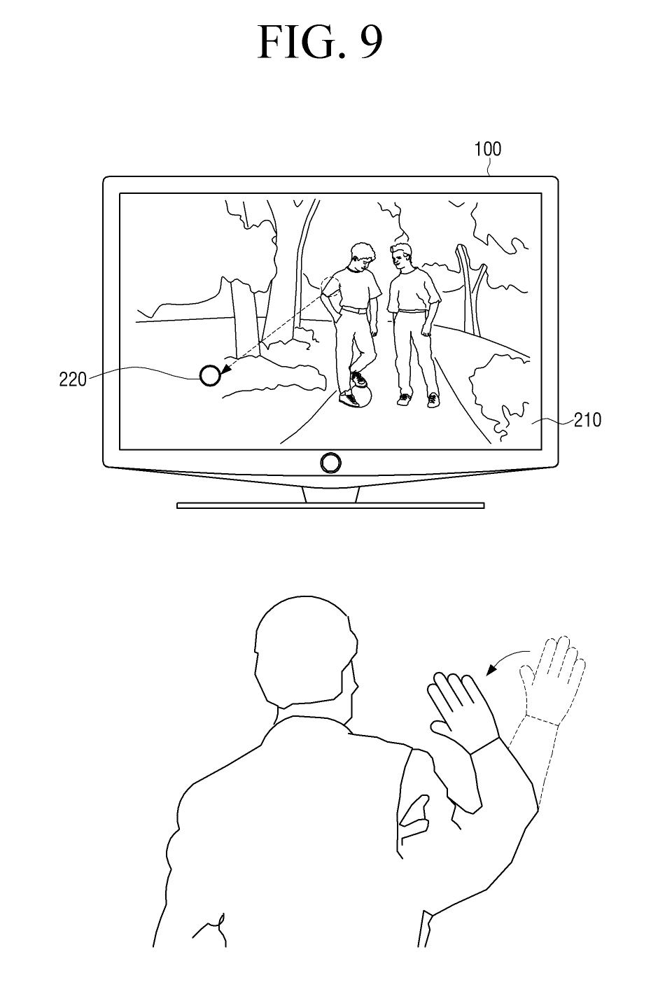

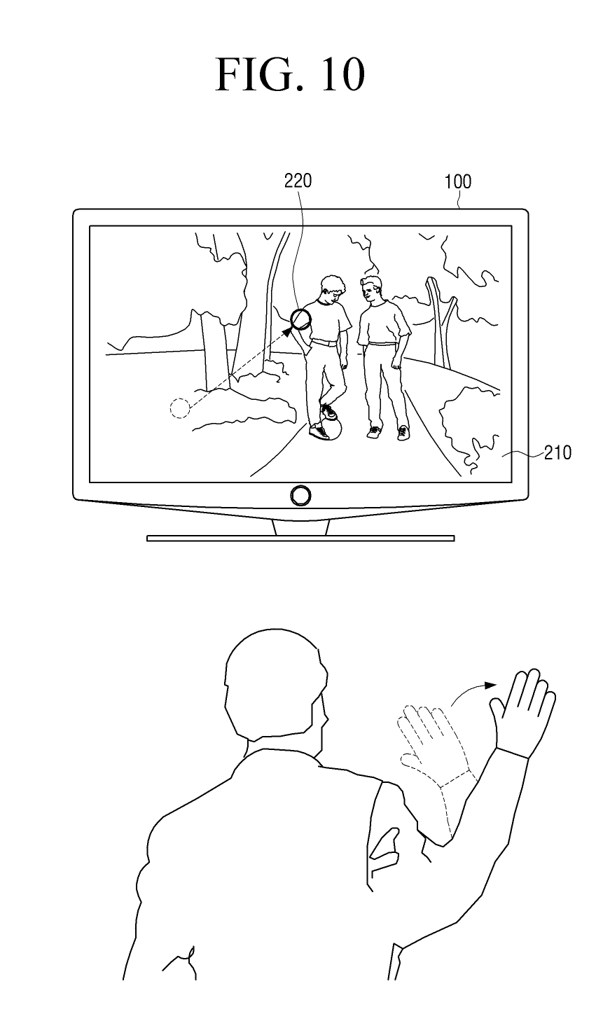

When the pointer 220 goes beyond a predetermined area according to a user's motion, the controller 130 may remove the GUI 230 from the screen, as illustrated in FIG. 9. In this case, even if the pointer 220 moves back to the predetermined area according to a user's motion, the controller 130 may control so that the GUI 230 is not displayed, as illustrated in FIG. 10.

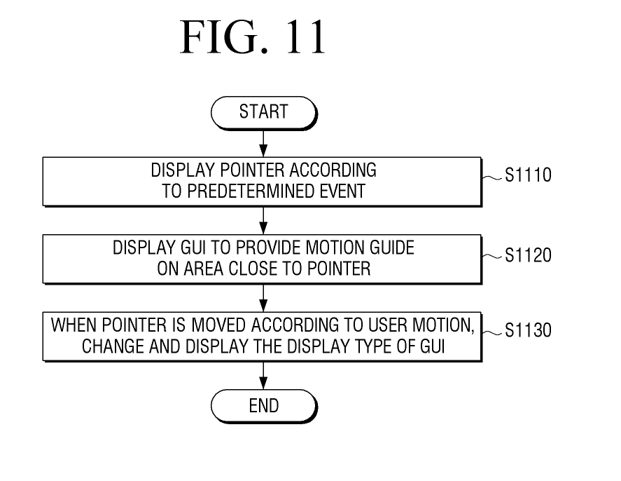

FIG. 11 is a flowchart which illustrates a method for controlling a display apparatus according to an exemplary embodiment.

First of all, a pointer to perform a motion task mode is displayed according to a predetermined event (operation S1110). In this case, the predetermined event may include a case where a motion start command is input. In addition, a GUI to provide a motion guide is displayed in an area close to the pointer (operation S1120).

In this case, the pointer and the GUI to provide a motion guide may be displayed at the center of the screen.

Meanwhile, when the pointer is moved according to a user motion, the display state of the GUI may be changed and displayed (operation S1130).

That is, when the pointer is moved within a predetermined area with reference to the location where the pointer is displayed for the first time, the transparency level of the GUI may be adjusted and displayed according to the location where the pointer is moved. Specifically, the transparency of the GUI may be increased gradually as the pointer is moved further away from the area where the pointer is displayed for the first time, within the predetermined area, and the transparency of the GUI may be decreased gradually as the pointer moves closer to the location where the pointer is displayed for the first time.

In addition, when the pointer goes beyond the predetermined area, the GUI may be removed, and even if the pointer moves back to the predetermined area, the display state of the GUI may be maintained in the removed state, that is, the GUI may still be removed from the screen.

Alternatively, when a predetermined time is elapsed since the pointer is displayed for the first time, the GUI may be removed.

When the GUI is selected by the pointer according to a user's motion, a guide regarding available motions in the motion task mode may be displayed. In this case, the guide may include information regarding tasks which can be executed by a user's motion. For example, the guide may include information that a GUI where a pointer is located can be selected by a grab motion, the pointer can be moved by a pointing move motion, channels can be changed by a left/right slap motion, and volume can be controlled by an up/down slap motion.

A non-transitory computer readable medium where a program for performing the controlling method according to an exemplary embodiment sequentially is stored may be provided.

Herein, the non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as a compact disk (CD), a digital versatile disk (DVD), a hard disk, a Blu-ray disk, a USB, a memory card, and a ROM and provided therein.

In addition, although a bus is not shown in the above block diagrams illustrating a display apparatus and a server, each component of the display apparatus and the server may be connected through a bus. In addition, each device may further comprise processors such as CPU, microprocessor, etc. which performs various operations.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for controlling a display apparatus, the method comprising:
displaying a pointer to perform a motion task mode according to a predetermined event;
displaying a Graphical User Interface (GUI) to provide a motion guide in an area adjacent to the pointer; and
when the pointer is moved according to a user's motion, changing and displaying a display state of the GUI.

2. The method as claimed in claim 1, further comprising:
when the GUI is selected by the pointer according to the user's motion, displaying a guide regarding available motions in the motion task mode.

3. The method as claimed in claim 1, wherein the changing and displaying a display state of the GUI comprises, when the pointer is moved within a predetermined area with reference to a location where the pointer is displayed initially, adjusting and displaying a transparency of the GUI according to a location where the pointer is moved.

4. The method as claimed in claim 3, wherein the changing and displaying a display state of the GUI comprises increasing and displaying a transparency of the GUI gradually as the pointer moves away from the location where the pointer is displayed initially, and decreasing and displaying a transparency of the GUI gradually as the pointer moves closer to the location where the pointer is displayed initially, within the predetermined area.

5. The method as claimed in claim 3, wherein the changing and displaying a display state of the GUI comprises removing the GUI from a display when the pointer goes beyond the predetermined area and maintaining the display state of the GUI in a removed state when the pointer moves back to the predetermined area.

6. The method as claimed in claim 1, wherein the changing and displaying a display state of the GUI comprises removing the GUI when a predetermined time is elapsed since the pointer is displayed initially.

7. A display apparatus, comprising:
a display;
a motion input device configured to receive a user's motion; and
a controller configured to display a pointer to perform a motion task mode according to a predetermined event, control the display to display a Graphical User Interface (GUI) to provide a motion guide in an area close to the pointer, move the pointer according to the user's motion, and change and display a display state of the GUI according to a motion of the pointer.

8. The apparatus as claimed in claim 7, wherein the controller, when the GUI is selected by the pointer according to the user's motion, the GUI displays a guide regarding available motions in the motion task mode.

9. The apparatus as claimed in claim 7, wherein the controller, when the pointer is moved within a predetermined area with reference to a location where the pointer is displayed initially, is configured to adjust and display a transparency of the GUI according to a location where the pointer is moved.

10. The apparatus as claimed in claim 9, wherein the controller is configured to increase and display a transparency of the GUI gradually as the pointer moves away from the location where the pointer is displayed initially, and decrease and display a transparency of the GUI gradually as the pointer moves closer to the location where the pointer is displayed initially, within the predetermined area.

11. The apparatus as claimed in claim 9, wherein the controller removes the GUI from a display when the pointer goes beyond the predetermined area and maintains the display state of the GUI in a removed state when the pointer moves back to the predetermined area.

12. The apparatus as claimed in claim 7, wherein the controller removes the GUI when a predetermined time is elapsed since the pointer is displayed initially.

13. A method for controlling a display apparatus, the method comprising:
displaying a pointer on a screen of the display apparatus according to a motion start command;
displaying a Graphical User Interface (GUI) adjacent to the pointer, and
changing a transparency level of the GUI based on a movement of the pointer within a predetermined area.

14. The method of claim 13, wherein the transparency of the GUI is increased gradually when the pointer is moved further away from a location where the pointer is displayed for the first time, within the predetermined area, and the transparency of the GUI is decreased gradually as the pointer moves closer to the location where the pointer was displayed for the first time.

15. The method of claim 13, wherein the GUI is removed from the screen of the display apparatus when the pointer is moved beyond the predetermined area.
